(19) United States
(12) Patent Application Publication
(10) Pub. No.: US 2013/0138855 A1
(43) Pub. Date: May 30, 2013

(54) STORAGE DEVICE WITH HOT-SPARE DISK, METHOD FOR STORAGE DEVICE DISK REPLACEMENT, AND DATA TRANSMISSION METHOD FOR DISK REPLACEMENT

(71) Applicants: CHING-HSIANG CHAN, Tu-Cheng (TW); HSIANG-TING CHENG, Tu-Cheng (TW)

(72) Inventors: CHING-HSIANG CHAN, Tu-Cheng (TW); HSIANG-TING CHENG, Tu-Cheng (TW)

(73) Assignee: HON HAI PRECISION INDUSTRY CO., LTD., Tu-Cheng (TW)

(21) Appl. No.: 13/532,798

(22) Filed: Jun. 26, 2012

(30) Foreign Application Priority Data
Nov. 25, 2011 (TW) 100143263

(51) Int. Cl. G06F 13/14

(52) U.S. Cl. 710/302

(57) ABSTRACT

A storage device includes a casing, non-hot-pluggable hard disks, and an operating portion. The casing includes a fringe area next to an exterior of the casing, and a central area in an interior of the casing. The non-hot-pluggable hard disks are positioned at the central area of the casing, and the hot-pluggable slots are positioned at the fringe area of the casing. The operating portion is located at the fringe area. Hot-pluggable slots are defined in the operating portion and are adapted for insertion of hot-pluggable hard disks therein. The disclosure also provides a related method storage device disk replacement, and a related data transmission method for storage device disk replacement.

### BACKGROUND

1. Technical Field

The present disclosure generally relates to a storage device with a plurality of hard disks, a working procedure for replacing one or more damaged hard disks, and a data transmission procedure when one or more damaged hard disks are replaced.

2. Description of Related Art

One conventional type of storage device has a plurality of individual hard disks mounted together, which cooperatively form a hard disk group according to an arrangement of the individual hard disks. This kind of arrangement expands the capacity of the storage device. Examples of such storage devices include the redundant array of independent disks (RAID), and just a bunch of disks (JBOD). Taking JBOD for instance, hot-pluggable hard disks are usually used for the storing of the data, to enable speedy reaction to hard disk damage and avoid data damage of a damaged hard disk. When a hard disk is damaged, the damaged hard disk is pulled out from the storage device and replaced by a new hard disk directly. Before the damaged hard disk is removed, data in the damaged hard disk is transmitted to a hot-spare hard disk by way of conventional reconstruction of the data of the damaged hard disk using other undamaged hot-pluggable hard disks already in the storage device. Then when the new hard disk has been installed, the reconstructed data is transmitted from the hot-spare hard disk to the new hard disk. Therefore each time a hard disk becomes damaged, the data of the hard disk has to, in effect, be transmitted twice in total: first from the damaged hard disk to the hot-spare hard disk, and then from the hot-spare hard disk to the new hard disk.

In addition, a typical storage device is housed in a computer casing. The computer casing has a front opening. The hot-pluggable hard disks among the hard disks of the storage device are usually positioned in a group near the opening of the computer casing. This arrangement enables the hot-pluggable hard disks to be conveniently removed from and inserted into the storage device. Nevertheless, such kind of arrangement may waste an interior space of the computer casing. Accordingly, in many instances, for saving space, cables and sliding rails are employed in the storage device. This allows more hot-pluggable hard disks to be mounted within the computer casing. When a hot-pluggable hard disk needs to be removed, the hot-pluggable hard disk is firstly slid along a corresponding pair of sliding rails to be exposed at or outside the opening of the computer casing. Then the hot-pluggable hard disk is detached from the computer casing. However, this kind of arrangement for the storage device is complex and hard to safeguard, which results in high cost.

Therefore, it is desired to provide a storage device and associated procedures which can overcome the above-described shortcomings

### BRIEF DESCRIPTION OF THE DRAWINGS

Many aspects of the disclosure can be better understood with reference to the following drawings. The components in the drawings are not necessarily drawn to scale, the emphasis instead being placed upon clearly illustrating the principles of the disclosure.

FIG. 1 is a schematic view of a storage device in accordance with an embodiment of the present disclosure.

FIG. 2 is a flow chart of a working procedure for replacing a damaged hard disk of the storage device of FIG. 1.

FIG. 3 is a flow chart of a data transmission procedure when two damaged hard disks of the storage device of FIG. 1 are replaced one after the other.

### DETAILED DESCRIPTION

Reference will now be made to the drawings to describe the present storage device, working procedure for replacing a damaged hard disk of the storage device, and data transmission procedure when two damaged hard disks of the storage device are replaced one after the other, in detail.

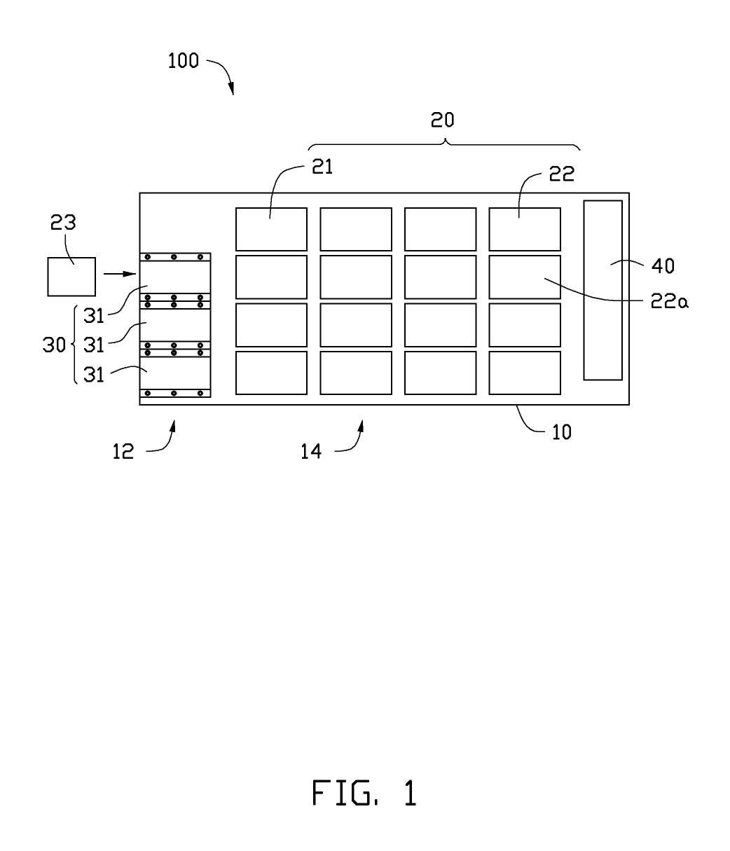

Referring to FIG. 1, a storage device 100 of an exemplary embodiment includes a casing 10, a plurality of hard disks 20, an operating portion 30 and a management control module 40.

The casing 10 is used for receiving the hard disks 20, the operating portion 30 and the management control module 40 therein. The casing 10 includes a fringe area 12 next to an exterior thereof, and a central area 14 in an interior thereof. Manual operations relating to the storage device 100 are conveniently performed at the fringe area 12.

The hard disks 20 are non-hot-pluggable hard disks, and are positioned at the central area 14. The hard disks 20 do not need to be pulled out from the casing 10 and replaced, even if they are damaged. As such, although the hard disks 20 are positioned in the central area 14 which (typically) cannot easily be reached by users, convenient manual operation of the storage device 100 is not substantially affected. In this embodiment, there are sixteen hard disks 20, which are arranged in an array of four rows and four columns in the casing 10. The hard disks 20 include at least one hot-spare disk 21, with the other hard disks 20 being non-hot-spare disks 22. If any one of the non-hot-spare disks 22 is damaged, the at least one hot-spare disk 21 can replace the damaged non-hot-spare disk 22 to keep the system steady. In the illustrated embodiment, there is a single hot-spare disk 21.

The operating portion 30 is located at the fringe area 12, and defines a plurality of slots 31 therein. Each of the slots 31 is a hot-pluggable slot 31. The number of slots 31 can be varied according to actual requirements. In this embodiment, there are three slots 31. If required, a new hot-pluggable hard disk 23 can be inserted into one of the slots 31 at the fringe area 12 at any time.

The management control module 40 is used for controlling operations when any one of the non-hot-spare disks 22 is damaged. In particular, the management control module 40 controls the damaged non-hot-spare disk 22 (hereinafter, “damaged hard disk 22”) to be replaced by the hot-spare disk 21, and controls the data stored in the damaged hard disk 22 to be transmitted to the hot-spare disk 21. Once the hot-spare disk 21 replaces the damaged hard disk 22, the data transmission procedure is typically as follows. First, one or more of the other non-hot-pluggable disks 20 cooperatively figure out what all the data stored in the damaged hard disk 22 is. Such figured out data can be called reconstructed data of the damaged hard disk 22, and the hot-spare disk 21 then obtains the reconstructed data from the other non-hot-pluggable disks 20 and stores the reconstructed data.

The management control module 40 also sends out a signal to remind users to insert a new hot-pluggable hard disk 23 (hereinafter, “new hard disk 23”) into one of the slots 31. When inserted into the slot 31, the new hard disk 23 automatically functions as a new hot-spare disk under control of the management control module 40, and is available for later use whenever needed. If another non-hot-spare disk 22a (hereinafter, “damaged hard disk 22a”) is damaged, the new hot-spare disk, i.e. the new hard disk 23, replaces the damaged hard disk 22a automatically, in much the same way as described above. At this time, the management control module 40 sends out a signal again to remind users to insert another new hot-pluggable hard disk 23 (not shown) into another one of the slots 31 to function as another new hot-spare disk available for later use whenever needed. Thus, data can be always transmitted from a damaged hard disk 22, 22a to an applicable hot-spare disk 21, 23 in time.

Unlike with a conventional storage device which replaces a damaged hard disk with a newly inserted hard disk directly, the data of the damaged hard disk 22, 22a of the storage device 100 is, in effect, transmitted only from the damaged hard disk 22, 22a to the applicable hot-spare disk 21, 23 each time a hard disk 22, 22a is damaged. That is, each time a hard disk 22, 22a is damaged, a total of only one transmission of the data of the damaged hard disk 22, 22a is required. Thereby, the data transmission load on the storage device 100 is reduced, and the efficiency of accessing data in the storage device 100 generally is improved. In addition, a total number of damaged hard disks 22, 22a that can be carried by the storage device 100 is determined by the number of slots 31 provided in the storage device 100.

Furthermore, a plurality of the hard disks 20 which are non-hot-pluggable hard disks 20 are positioned in rows inside the casing 10, and the operating portion 30 including a column of the hot-pluggable slots 31 is positioned next to the exterior of the casing 10. This kind of arrangement can increase a density of the hard disks 20 arranged in the storage device 100 and improve a storage capability of the storage device 100. If any one of the hard disks 22, 22a positioned in the central area 14 is damaged, the existing hot-spare disk 21 can be utilized or an already-inserted hot-pluggable hard disk 23 can be utilized without the needed for pulling the damaged hard disk 22, 22a out from the casing 10. Moreover, because an operation of pulling the damaged hard disk 22, 22a out from the casing 10 is omitted, there is no risk of data damage occurring due to pulling a wrong hard disk 22, 22a out.

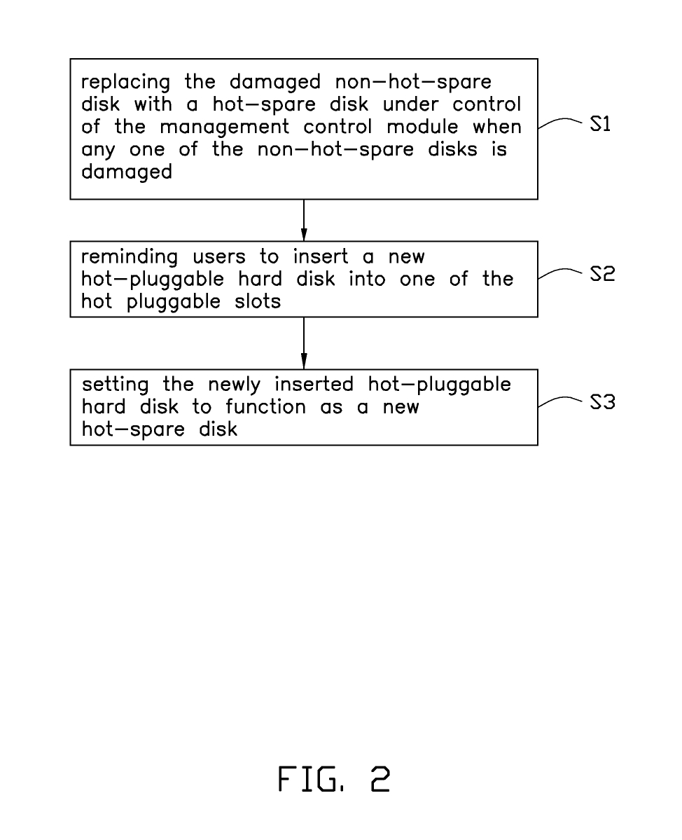

Referring to FIG. 2, an exemplary working procedure for replacing a damaged hard disk 22 of the storage device 100 is further provided. The working procedure includes the following steps.

Firstly, in step S1, the damaged hard disk 22 is replaced by the hot-spare disk 21 under the control of the management control module 40 when any one of the non-hot-spare disks 22 is damaged.

Secondly, in step S2, the new hot-pluggable hard disk 23 is inserted into one of the slots 31, according to a reminder sent by the management control module 40 to users.

Thirdly, in step S3, the new hot-pluggable hard disk 23 is set to function as a new hot-spare disk 23 under control of the management control module 40.

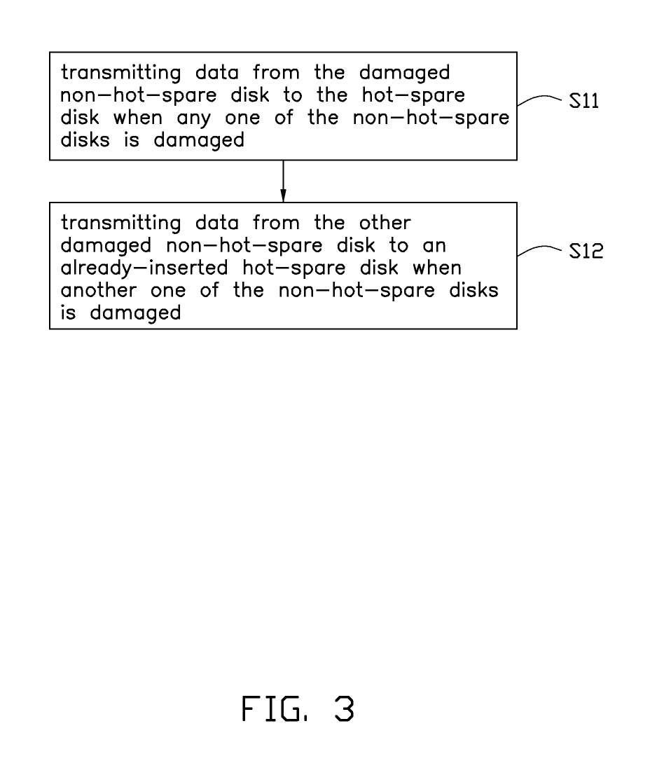

Referring to FIG. 3, an exemplary data transmission procedure when two damaged hard disks 22, 22a of the storage device 100 are replaced one after the other is further provided. The data transmission procedure includes the following steps.

Firstly, in step S11, the data stored in the damaged non-hot-spare hard disk 22 is transmitted to the hot-spare disk 21 when any one of the non-hot-spare disks 22 is damaged.

Secondly, in step S12, the data stored in the damaged hard disk 22a is transferred to the already-inserted hot-spare disk 23 when the hard disk 22a is damaged.

It is to be understood that the above-described embodiments are intended to illustrate rather than limit the disclosure. Variations may be made to the embodiments without departing from the spirit of the disclosure as claimed. The above-described embodiments illustrate the scope of the disclosure but do not restrict the scope of the disclosure.

What is claimed is:

1. A storage device comprising:
a casing comprising a fringe area next to an exterior of the casing and a central area in an interior of the casing;
a plurality of non-hot-pluggable hard disks positioned at the central area of the casing; and
an operating portion located at the fringe area, a plurality of hot-pluggable slots being defined in the operating portion and adapted for insertion of a plurality of hot-pluggable hard disks therein.

2. The storage device of claim 1, wherein the non-hot-pluggable hard disks are arranged in an array at the central area of the casing.

3. The storage device of claim 1, wherein the non-hot-pluggable hard disks comprise at least one hot-spare disk and a plurality of non-hot-spare disks, the at least one hot-spare disk provided for replacing the damaged non-hot-spare disk when any one of the non-hot-spare disks becomes damaged.

4. The storage device of claim 3, further comprising a management control module configured for controlling the damaged non-hot-spare disk to be replaced by the hot-spare disk and data stored in the damaged non-hot-spare disk to be transmitted to the hot-spare disk, and further configured for sending out a signal to remind one or more users to insert a hot-pluggable hard disk into one of the hot-pluggable slots of the operating portion.

5. The storage device of claim 1, wherein the plurality of hot-pluggable slots comprises three hot-pluggable slots.

6. A method for storage device disk replacement, wherein a storage device comprises a plurality of non-hot-pluggable hard disks, an operating portion comprising a plurality of hot-pluggable slots, and a management control module, the non-hot-pluggable hard disks comprising at least one hot-spare disk and a plurality of non-hot-spare disks, the method comprising:
replacing the damaged non-hot-spare disk with one of the at least one hot-spare disk under control of the management control module when any one of the non-hot-spare disks is damaged;
inserting a hot-pluggable hard disk into one of the hot-pluggable slots, according to a reminder sent by the management control module to one or more users; and
setting the hot-pluggable hard disk to function as a new hot-spare disk under control of the management control module.

7. A data transmission method for storage device disk replacement, wherein a storage device comprises a hot-spare disk, a plurality of non-hot-spare disks, and a plurality of hot-pluggable slots, the method comprising:
transmitting data from the damaged non-hot-spare disk to the hot-spare disk when any one of the non-hot-spare disks is damaged; and
transmitting data from the other damaged non-hot-spare disk to a hot-spare disk already inserted into one of the hot-pluggable slots when another one of the non-hot-spare disks is damaged.

8. The method of claim 7, wherein transmitting data from the damaged non-hot-spare disk to the hot-spare disk comprises one or more of the other undamaged non-hot-spare disks cooperatively figuring out what the data stored in the damaged non-hot-spare disk is.

9. The method of claim 7, wherein transmitting data from the other damaged non-hot-spare disk to a hot-spare disk already inserted into one of the hot-pluggable slots comprises one or more of the other undamaged non-hot-spare disks cooperatively figuring out what the data stored in the other damaged non-hot-spare disk is.
